(19) United States
(12) Patent Application Publication
(10) Pub. No.: US 2015/0257145 A1
(43) Pub. Date: Sep. 10, 2015

(54) CONFIGURING WIRELESS SERVICE

(71) Applicants: Yong Teng, Beijing (CN); Lei Du, Beijing (CN)

(72) Inventors: Yong Teng, Beijing (CN); Lei Du, Beijing (CN)

(73) Assignee: NOKIA SOLUTIONS AND NETWORKS OY, Espoo (FI)

(21) Appl. No.: 14/428,170

(22) PCT Filed: Sep. 14, 2012
(86) PCT No.: PCT/CN2012/081399

§ 371 Date: Mar. 13, 2015

(51) Int. Cl. H04W 72/04; H04W 36/16

(52) U.S. Cl. CPC H04W 72/0413; H04W 36/165; H04W 36/38

(57) ABSTRACT

Methods and apparatus for controlling a wireless service provided for a communication device by a network is disclosed. A communication device served by at least one node of a network determines at least one desired characteristic of the wireless service and thereafter triggers configuration of the wireless service by sending from the communication device to the network a message containing information that is based on the at least one determined desired characteristic. A node of the network receives the message, and in response thereto, causes configuration of the wireless service based on the received information.

### TECHNICAL FIELD

This disclosure relates to wireless communications and more particularly to configuration of a wireless service for at least one communication device in a communication system.

### BACKGROUND

A communication system can be seen as a facility that enables communication sessions between two or more entities such as fixed or mobile communication devices, machine-type terminals, base stations, servers and/or other communication nodes. A communication system and compatible communicating entities typically operate in accordance with a given standard or specification which sets out what the various entities associated with the system are permitted to do and how that should be achieved. In a wireless communication system at least a part of communications occurs over a wireless link. Examples of wireless systems include public land mobile networks (PLMN) such as cellular networks, satellite based communication systems and different wireless local networks, for example wireless local area networks (WLAN). A wireless system can be divided into cells or other radio coverage or service areas.

A user can access the communication system by means of an appropriate communication device. A communication device of a user is often referred to as user equipment (UE) or terminal. A communication device is provided with an appropriate signal receiving and transmitting arrangement for enabling communications with other parties. In a wireless system a communication device provides a transceiver station that can communicate with another communication node such as e.g. a base station and/or another user equipment. Resources are allocated by the system for the communications such that simultaneous operation of a plurality transmitting and receiving devices is enabled. A network of base stations and/or individual base stations and various aspects of the communications as well as the user equipment can be operated in accordance with a configuration managed by one or more appropriate network control entities.

An example of communication systems is an architecture that is being standardized by the 3rd Generation Partnership Project (3GPP). This system is often referred to as the long-term evolution (LTE) of the Universal Mobile Telecommunications System (UMTS) radio-access technology. A further development of the LTE is often referred to as LTE-Advanced (LTA-A). The various development stages of the 3GPP LTE specifications are referred to as releases.

An example of base stations is enhanced NodeB (eNB). In LTE-A a node providing a relatively wide coverage area is referred to as a macro eNode B. Network nodes can also provide smaller service areas. Examples of such smaller or local radio service area network nodes include femto nodes such as Home eNBs (HeNB), pico nodes such as pico eNodeBs (pico-eNB), micro nodes and remote radio heads. A smaller radio service area can be located wholly or partially within one or more larger radio service areas. Different radio technologies may be used at the same time in a multi-layered system. Multi-layered systems are often referred to as heterogeneous networks or Hetnets. An example of a multi-layered system is a mixture of macro base stations and small power base stations (e,g. pico and micro stations). The various layers can be deployed as part of a cellular network. It is noted that a multi-layer LTE network is used herein only as an example of multi-layered systems and that other solutions are also possible.

Hetnets are evolving to what are termed herein as “denser networks”, or networks where multiple nodes are densely deployed to serve devices in the area. A good user experience and high data rate requirement from the communication devices are of high importance is such networks. In a denser network the number of infrastructure nodes can be larger or equal to the number of the communication devices such as user equipment (UEs). A communication device can also be served by a multiple of nodes or cells. These multiple nodes in a neighbourhood shall have a good coordination, and are typically forming a cluster. A cluster head may be provided as a central controller handling the coordination and negotiations among the nodes. The cluster head could be a separate network entity, or could locate inside any of the nodes.

Aspects such as resource allocation, management and so on are provided under control of one or more elements in the network. There are some unresolved issues in this regard. For example, traffic in a local area can be vary and be asymmetric. The variations may take place rapidly, and be unpredictable. Different nodes may have different uplink/downlink (UL/DL) configurations. Because of the increased use of smartphones each mobile device can have substantially time-varying traffic profile due to diverse applications.

### SUMMARY

Embodiments of the invention aim to address one or several of the above issues.

In accordance with an embodiment there is provided a method for controlling a wireless service provided for a communication device, comprising determining at the communication device served by at least one node of a network at least one desired characteristic of the wireless service, and triggering configuration of the wireless service by sending from the communication device to the network a message containing information that is based on the at least one determined desired characteristic.

In accordance with an embodiment there is provided a method for controlling a wireless service provided for a communication device by at least one node, comprising receiving at a node of a network a message for triggering configuration of the wireless service, the message containing information that has been determined by the communication device based on at least one determined desired characteristic of the wireless service, and in response thereto, causing configuration of the wireless service based on the received information.

In accordance with an embodiment there is provided an apparatus for a wireless device, the apparatus comprising at least one processor, and at least one memory including computer program code, wherein the at least one memory and the computer program code are configured, with the at least one processor, to determine at the communication device at least one desired characteristic of a wireless service provided by at least one node of a network, and trigger configuration of the wireless service by sending to the network a message containing information that is based on the at least one determined desired characteristic.

In accordance with an embodiment there is provided an apparatus for a node in a wireless network, the apparatus comprising at least one processor, and at least one memory including computer program code, wherein the at least one memory and the computer program code are configured, with the at least one processor, to receive a message for triggering configuration of a wireless service, the message containing information that has been determined by a communication device based on at least one determined desired characteristic of the wireless service, and in response thereto, cause configuration of the wireless service based on the received information.

In accordance with a more detailed aspect, capability of at least one serving node and/or at least one other node of providing the wireless service as indicated by the message is determined. The configuration of the wireless service is then caused accordingly. The determining may be provided at a serving node or a cluster head. The at least one serving node or the cluster head may communicate instructions to the at least one other node based on the determination. Negotiation with the at least one other node about its capabilities to provide the wireless service may be provided. Handover of the communication device to the at least one other node may be performed. Handover cause information indicating improper configuration may be included in a request for handover.

A serving pattern may be determined based on the information from the communication device and negotiations between nodes of the network, the serving pattern defining the serving pattern defining how the wireless service is provided for the communication device by a plurality of nodes. The serving pattern may be communicated from a node of a cluster to at least one other node of the cluster and further from the at least one other node to the communication device.

The message for triggering may comprise information about uplink/downlink traffic ratio expected by the communication device and/or uplink/downlink configuration desired by the communication device and/or at least one candidate cell. The message for triggering the change in configuration may be sent in response to the communication device detecting an event indicative of a need for change in the configuration of the wireless service. The detection of the event may comprise detection of at least one of a predefined change in uplink/downlink traffic ratio, a predefined change in power consumption and a change in configuration from the serving node and/or a neighbouring node.

The desired characteristic determined by the communication device may comprise at least one of expected uplink/downlink traffic ratio, preferred uplink/downlink configuration and uplink/downlink configuration of at least one neighbouring cell.

The communication device may be served by a plurality of nodes. The network can comprise more nodes than there are communication devices served by the nodes.

Nodes implementing the embodiments may be provided. A node can be provided by an apparatus for controlling a base station, for example an enhanced NodeB. The control and station apparatus may be integrated. A node can also be provided by a control entity such as a cluster head or a mobile device.

A computer program comprising program code means adapted to perform the claimed method may also be provided.

Various other aspects and further embodiments are also described in the following detailed description and in the attached claims.

### BRIEF DESCRIPTION OF THE DRAWINGS

The invention will now be described in detail, by way of example only, with reference to the following examples and accompanying drawings, in which:

FIG. 1 shows a schematic diagram of a network according to some embodiments;

FIG. 2 shows a schematic diagram of a mobile communication device according to some embodiments;

FIG. 3 shows a schematic diagram of a control apparatus according to some embodiments;

FIGS. 4A and B show flow charts according to certain embodiments for operation at a communication device and a network element, respectively;

FIGS. 5 and 6 show signalling flows illustrating certain embodiments; and

FIGS. 7(a) and (b) relates to an example of a serving pattern.

### DETAILED DESCRIPTION

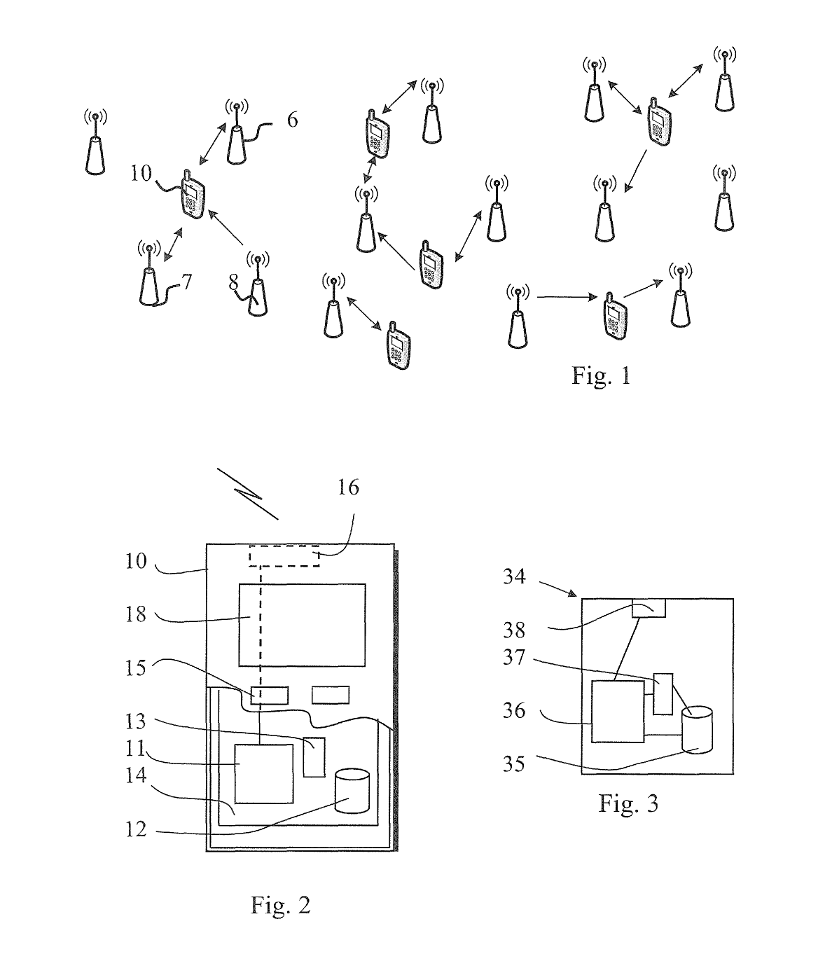

In the following certain exemplifying embodiments are explained with reference to a wireless or mobile communication system serving mobile communication devices. Before explaining in detail the exemplifying embodiments, certain general principles of a wireless communication system and mobile communication devices are briefly explained with reference to FIGS. 1 to 3 to assist in understanding the technology underlying the described examples.

In a wireless communication system mobile communication devices or user equipment (UE) 10 are provided wireless access via at least one base station or similar wireless transmitting and/or receiving network nodes, each providing at least one cell. In the FIG. 1 example a plurality of communications devices 10 and base stations 6, 7 and 8 are shown. As shown, the density of the networks nodes can be relatively high, and the number thereof exceeding the number of communication devices. Such arrangements are referred to herein as “denser networks”.

Each mobile communication device and network node may have one or more radio channels open at the same time and may send signals to and/or receive signals from more than one source. A network node is typically controlled by at least one appropriate controller apparatus so as to enable operation thereof. The control apparatus can be interconnected with other control entities. The control apparatus is typically provided with memory capacity and at least one data processor. The control apparatus and functions may be distributed between a plurality of control units.

A non-limiting example of the recent developments in communication system architectures is the long-term evolution (LTE) of the Universal Mobile Telecommunications System (UMTS) that is being standardized by the 3rd Generation Partnership Project (3GPP). As explained above, further development of the LTE is referred to as LTE-Advanced. Non-limiting examples of LTE access nodes are macro level base stations known as NodeB (NB) and enhanced NodeB (eNB) in the vocabulary of the 3GPP specifications. Home eNBs (HeNB), pico eNodeBs (pico-eNB), femto nodes, and radio remote heads (RRH) connected to an eNB. The LTE employs a mobile architecture known as the Evolved Universal Terrestrial Radio Access Network (E-UTRAN). Base stations of such systems (evolved or enhanced Node Bs) provide E-UTRAN features such as user plane Radio Link Control/Medium Access Control/Physical layer protocol (RLC/MAC/PHY) and control plane Radio Resource Control (RRC) protocol terminations towards the user devices. Of these Radio Resource Control (RRC) protocol is used to configure and control the radio resource between eNodeBs and user equipment. For example, RRC is used to configure the RLC/MAC and PHY layer at a user equipment and eNodeB. Other examples of radio access system include those provided by base stations of systems that are based on technologies such as wireless local area network (WLAN) and/or WiMax (Worldwide Interoperability for Microwave Access).

A possible mobile communication device will now be described in more detail in reference to FIG. 2 showing a schematic, partially sectioned view of a communication device 20. Such a communication device is often referred to as user equipment (UE) or terminal. An appropriate mobile communication device may be provided by any device capable of sending and receiving radio signals. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. Users may thus be offered and provided numerous services via their communication devices. Non-limiting examples of these services include two-way or multi-way calls, data communication or multimedia services or simply an access to a data communications network system, such as the Internet. User may also be provided with broadcast or multicast data. Non-limiting examples of the content include downloads, television and radio programs, videos, advertisements, various alerts and other information. A number of services can be provided by means of applications downloaded on the device. The mobile device may receive signals over an air interface via appropriate apparatus for receiving and may transmit signals via appropriate apparatus for transmitting radio signals. In FIG. 2 transceiver apparatus is designated schematically by block 16. The transceiver apparatus 16 may be provided for example by means of a radio part and associated antenna arrangement. The antenna arrangement may be arranged internally or externally to the mobile device.

A mobile device is also typically provided with at least one data processing entity 11, at least one memory 12 and other possible components 13 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 14. The control apparatus of a user equipment can be configured to process information in association with determining desired service characteristics and controlling communications in relation to configuring the wireless services.

FIG. 3 shows an example of a control apparatus for a node of a communication system, for example to be coupled to and/or for controlling a wireless node and/or a node for controlling a cluster of wireless nodes. The control apparatus can be configured to provide control functions in association with processing information received from communication device and deciding how to provide a configuration that best satisfies needs of the individual communication devices in accordance with certain embodiments described below. For this purpose the control apparatus comprises at least one memory 35, at least one data processing unit 36, 37 and an input/output interface 38. Via the interface the control apparatus can be coupled to a receiver and a transmitter of the base station. The control apparatus can be configured to execute an appropriate software code to provide the control functions. It shall be appreciated that similar components can be provided in a control apparatus provided elsewhere in the system.

Time division duplexing (TDD) is a possible choice for communications in the system of FIG. 1 in circumstances where traffic in a local area can be variable and asymmetric. A dynamic TDD network can be provided for a denser network where different nodes may have different uplink/downlink (UL/DL) configurations. Communication devices such as smartphones can feature a time-varying traffic profile due to diverse applications and use thereof. The inventors have recognised that operations in a network such as a denser network may in certain occasions be preferred to be user device centric rather than cell centric. For example, aspects such as resource allocation, management and so on could be provided based on information about the needs of a user device rather than a cell, or at least giving more weight on the needs of individual devices. It can be assumed that a user device has better awareness of applications that are running on it than what a network could do. Thus the device is in a good position to assist in the network configuration concerning its traffic variation.

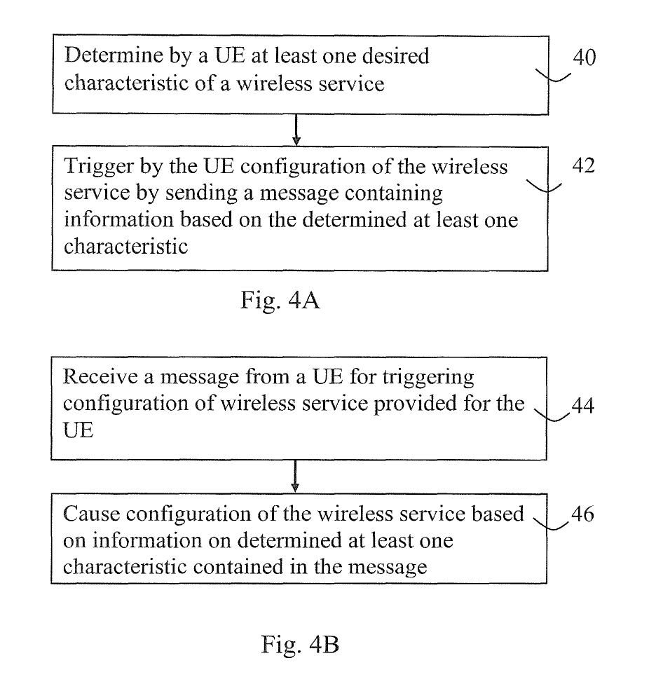

FIG. 4A shows a flowchart for operation at a communication device served by at least one node of a network. The device can determine at 40 at least one desired characteristic of the wireless service. The device then triggers at 42 configuration of the wireless service by sending to the network a message containing information that is based on the at least one determined desired characteristic.

FIG. 4B relates to operation at the network side, for example in a node serving the communication device or a cluster head for controlling a wireless service provided for the communication device by a network. The node can receive at 46 a message for triggering configuration of the wireless service. The message contains information that has been determined by the communication device at step 40 of FIG. 4A. In response to the triggering message, the node causes at 48 configuration of the wireless service based on the received information.

In accordance with an embodiment, a node receiving the information determined by the communication device determines first whether a node serving the communication device is capable of providing the wireless service as indicated by the information. This determination can be made by the serving node or by another entity, for example a cluster head. In response to the determination the configuration of the serving node is adjusted. If this is not feasible, a message is sent to another node based on the information received from the communication device for instructing the other node to configure itself accordingly. The sending of the instructions may comprise forwarding of the message or relevant information content thereof received from the communication device. Alternatively, a new message is generated. For example, a request for configuration in accordance with the information received from the communication device or a request for a handover may be generated.

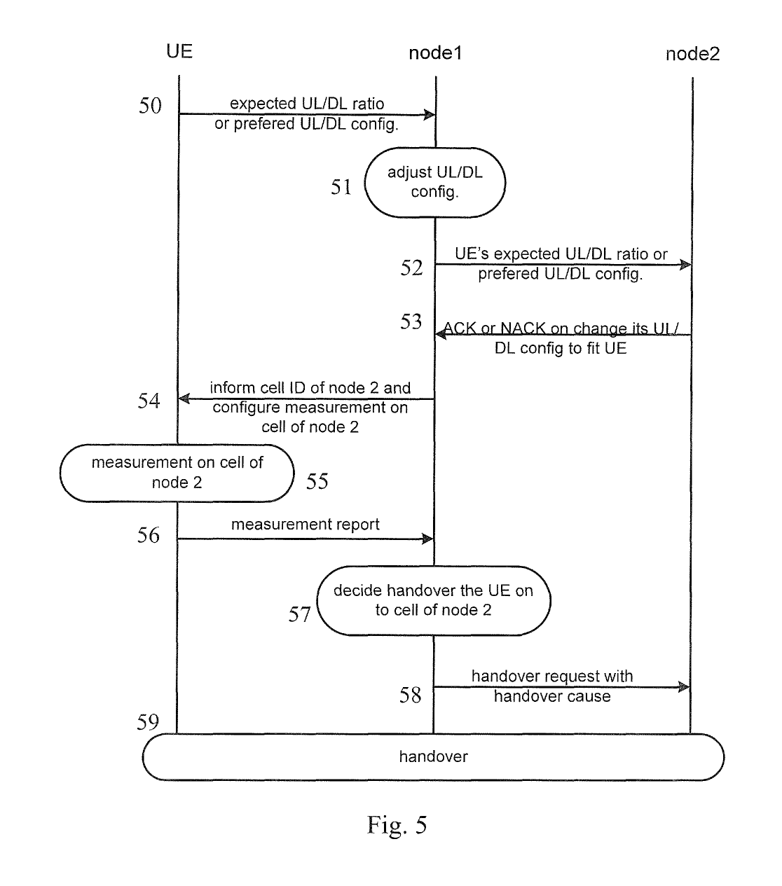

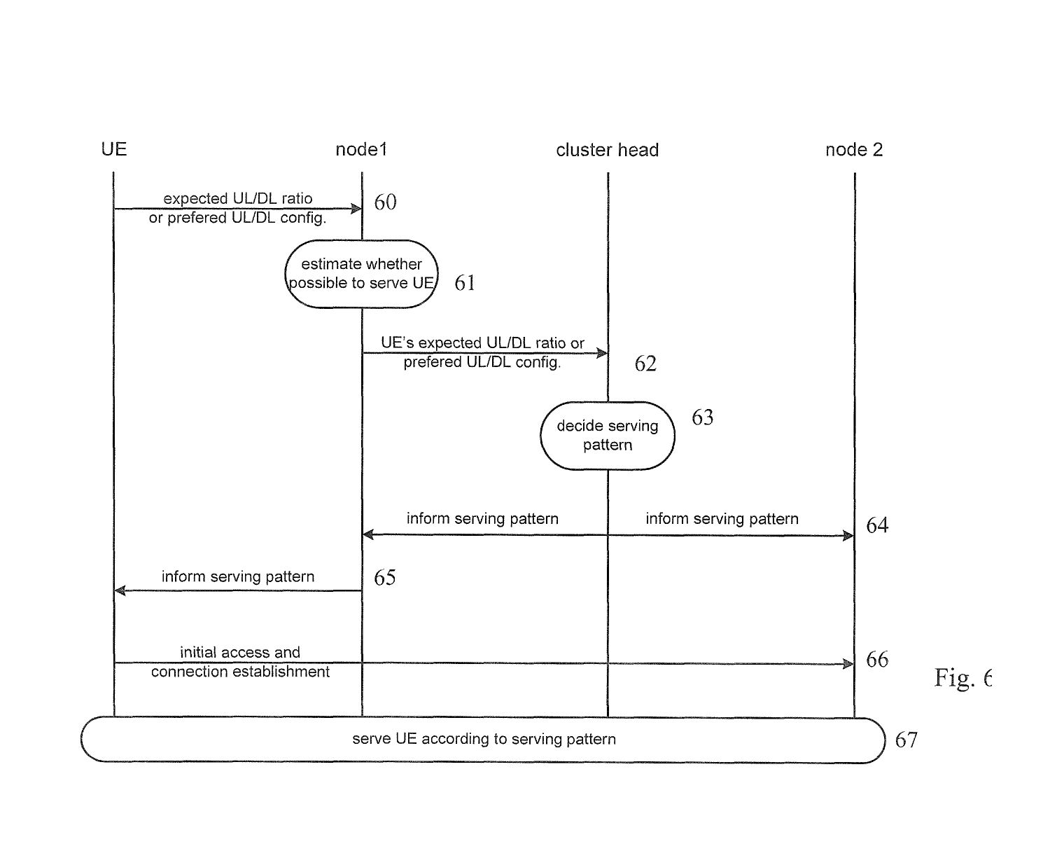

More detailed examples for user equipment (UE) centric traffic adapted network configuration for a denser network are described below with reference to FIGS. 5 and 6 and to a network such as denser network. A denser network may be provided as an evolved LTE Hetnet. In the scheme, network configuration is initiated by UE. The configuration can be based on traffic adaptation. Optimization based on coordination between nodes within a cluster is also provided.

In the example of FIG. 5 it is assumed a communication device, UE, is served by single node i.e. node 1. The UE can provide assistance information for one or more nodes of the network based on a determined desired characteristic. For example, the UE can estimate its expected UL/DL traffic ratio and/or preferred UL/DL configuration. The estimation can be based e.g. on traffic prediction from diverse applications, power requirement, and/or other factors. The UE may also evaluate the UL/DL configurations of its neighbouring cells e.g. via measurements, and inform its serving cell the applicability if it fits better its preferred UL/DL configuration.

The estimation may be provided in response to detection of a predefined event. The event which triggers the operation can include e.g. detection that UL/DL traffic ratio is changing considerably. For example, this may occur when the UE starts using a new application. There can also be a detectable change on power consumption of the user equipment, e.g. the available power level is detected to be below a predefined threshold. It can also be detected that there is a change of UL/DL configuration from serving cell and/or neighbouring cell.

The UE then sends the determined assistance information by message 50 to a serving node (node 1). This node can be one of the nodes capable of serving the UE at the time that is not necessarily providing any active service. The UE may also send information on at least one candidate cell which may fit its preferred UL/DL traffic ratio or configuration.

After receiving the assistance information from the UE, the serving node can adjust at 51 the cell's UL/DL configuration based on the expected UL/DL traffic ratio of the UE or a preferred UL/DL configuration of the UE, if possible. It can be determined at this stage if the impact to other UEs is tolerable, and/or if other UEs served by the node have been handed over to other nodes and/or have less amount of traffic in a predefined future period.

If the serving node cannot adjust its UL/DL configuration, it can inform by message 52 other nodes of the expected UL/DL traffic ratio or preferred UL/DL configuration of the UE.

Neighbouring nodes (node 2 in FIG. 5 example) can then perform a check if it is possible to serve the UE. For example, a check can be made to see if any changes are needed (no changes would mean an easy option to serve the UE) or what adjustment is needed in the respective cell's UL/DL configuration, and if these changes are feasible. If it is possible to serve the UE by the neighbouring node, the node (node 2) can reply by an appropriate message 53 to acknowledge this to the source node (node 1). A negative acknowledgement can be sent in case it is not possible or desirable for the neighbouring node to serve the UE.

In the case of positive acknowledgement, the source node can inform the UE of the new node by message 54 and configured necessary measurements. The UE measures the new cell at 55 and sends a measurement report 56 back to the source node.

Source node can then decide at 57 to handover the UE to the selected neighbour node wherefrom the positive acknowledgement was received. A handover request 58 is thus sent to the target node (node2). In the handover request, the source node can indicate a handover cause, e.g. that the reason for the handover is improper UL/DL configuration, to target node to avoid ping-pang effect.

Other examples are now explained with reference to FIG. 6. A base assumption in the FIG. 6 examples is that the UE can be served by a multiple of nodes (node 1 and node 2 in the Figure). This can be realized for example via techniques such as inter-site carrier aggregation, coordinated multipoint (CoMP) communications, softcell, Routeing Area Update (RAU) etc. In a denser network deployment a cluster of nodes within a neighbourhood may be set up to have better coordination. Within the cluster, one node can be designated to provide a cluster head. The designation can be provided for example by an Operations Administration and Maintenance (OAM) function. The cluster head acquires basic configurations for all the nodes within the cluster from the OAM. The cluster head can be a separate network entity, or can locate inside any of the nodes of the cluster.

An event can trigger the UE to send a message 60 containing assistance information such as the expected UL/DL traffic ratio of the UE and/or preferred UL/DL configuration to at least one of serving nodes. After receiving the UE's assistance information, the serving node can adjust at 61 its cell UL/DL configuration, if possible, and report this to the cluster head by message 62. If this is not possible, the serving node can report UE's expected UL/DL traffic ratio or preferred UL/DL configuration to the cluster head.

According to a possibility the user equipment send the assistance information directly to the cluster head. The cluster head the takes appropriate action to arrange at least one node to provide a configuration that satisfies the needs of the user equipment.

The cluster head may ask one node belonging to the cluster to change its configuration to a UL/DL configuration preferred by the UE. The cluster head can then inform the serving node to handover the UE to that node. Before that, if necessary, the cluster head may activate respective nodes which are switched off previously.

The cluster head can also decide at 63 a serving pattern for the UE, based on negotiation results within the cluster. The serving pattern defines how the wireless service is provided for the communication device by a plurality of nodes. Thus the serving pattern can describe which node within the cluster will serve a UE at a specific time duration, for example in one or more frames or subframes. Generally the serving pattern can include information such as for example cell ID of the nodes, serving frame or subframe, link direction, frequency and mapping thereof. The serving pattern can be used to enable flexible implementation of UE's preferred UL/DL traffic ratio or UL/DL configuration.

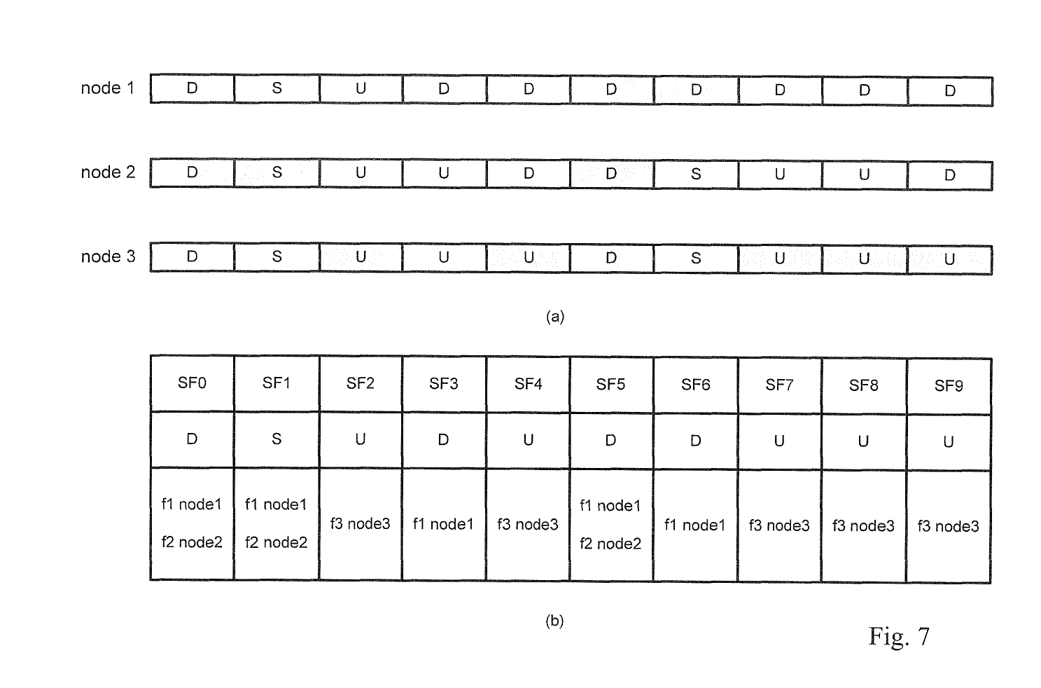

An example of the principles of a serving pattern is shown in FIG. 7. Part (a) of the figure shows highlighted subframes that denote served subframes, link direction, frequency and serving nodes. Part (b) shows a serving pattern delivered for a UE.

The cluster head can send the serving pattern to one or other nodes in the cluster. For example, the cluster head can advertise the serving pattern within the cluster at 64. The serving node can then inform by message 65 the UE of the serving pattern. UEs are then connected to the selected nodes at 66 and served according to the serving pattern at 67. This can be especially useful when inter-site carrier aggregation (CA) is used at UE.

In this description the term node is used to refer to an apparatus providing wireless access for a communication device such as a user equipment (UE). The node can be provided e.g. by an eNB as shown in FIG. 1. Although in the above it is assumed there is one cell for each node, it is possible to extend the same principles to multiple cells within one node/eNB. A node thus provides one or more cells, and the term node can be replaced by cell where appropriate.

It is noted that these embodiments are only examples, and that the relevant messages and/or operations can be provided in changed order.

The described embodiments may provide a communication device centric operation to enable good user experience and high data rates. The knowledge readily available for the communication device can be used to assist in network configuration. The embodiments may allow for a flexible DL/UL resource allocation taking advantage of multiple cells.

The required data processing apparatus and functions of a control apparatus for the determinations and control of configuration at a communication device, a base station and any other node or element may be provided by means of one or more data processors. The described functions may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

An appropriately adapted computer program code product or products may be used for implementing the embodiments, when loaded or otherwise provided on an appropriate data processing apparatus. The program code product for providing the operation may be stored on, provided and embodied by means of an appropriate carrier medium. An appropriate computer program can be embodied on a computer readable record medium. A possibility is to download the program code product via a data network. In general, the various embodiments may be implemented in hardware or special purpose circuits, software, logic or any combination thereof. Embodiments of the inventions may thus be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

It is noted that whilst embodiments have been described in relation to LTE-Advanced and possible future developments thereof, similar principles can be applied to any other communication system. Therefore, although certain embodiments were described above by way of example with reference to certain exemplifying architectures for wireless networks, technologies and standards, embodiments may be applied to any other suitable forms of communication systems than those illustrated and described herein.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. For example, a combination of one or more of any of the other embodiments previously discussed can be provided. All such and similar modifications of the teachings of this invention will still fall within the scope of this invention as defined in the appended claims.

1. A method for controlling a wireless service provided for a communication device, comprising:
determining at the communication device served by at least one node of a network at least one desired characteristic of the wireless service, and
triggering configuration of the wireless service by sending from the communication device to the network a message containing information that is based on the at least one determined desired characteristic.

2. A method for controlling a wireless service provided for a communication device by at least one node, comprising:
receiving at a node of a network a message for triggering configuration of the wireless service, the message containing information that has been determined by the communication device based on the at least one determined desired characteristic of the wireless service, and
in response thereto, causing configuration of the wireless service based on the received information.

3. A method according to claim 1, comprising determining the capability of at least one serving node and/or at least one other node of providing the wireless service as indicated by the message, and causing the configuration of the wireless service accordingly.

4. A method according to claim 3, wherein the determining is provided at a serving node or a cluster head.

5. A method according to claim 4, comprising sending from the at least one serving node or the cluster head instructions to the at least one other node based on the determination.

6. A method according to claim 3, comprising negotiating with the at least one other node about its capabilities to provide the wireless service and causing handover of the communication device to the at least one other node.

7. A method according to claim 6, comprising including handover cause information indicating improper configuration in a request for handover.

8. A method according to claim 1, comprising determining a serving pattern based on the information from the communication device and negotiations between nodes of the network, the serving pattern defining how the wireless service is provided for the communication device by a plurality of nodes.

9. A method according to claim 8, comprising communicating the serving pattern from a node of a cluster to at least one other node of the cluster, and further from the at least one other node to the communication device.

10. A method according to claim 1, wherein the message comprises information about uplink/downlink traffic ratio expected by the communication device and/or uplink/downlink configuration desired by the communication device and/or at least one candidate cell.

11. A method according to claim 1, comprising sending the message for triggering the change in configuration in response to the communication device detecting an event indicative of a need for change in the configuration of the wireless service.

12. A method according to claim 11, wherein the detection of the event comprises detection of at least one of a predefined change in uplink/downlink traffic ratio, a predefined change in power consumption and a change in configuration from the serving node and/or a neighbouring node.

13. A method according to claim 1, wherein the communication device is serviced by a plurality of nodes.

14. A method according to claim 1, wherein the desired characteristic determined by the communication device comprises at least one of expected uplink/downlink traffic ratio, preferred uplink/downlink configuration and uplink/downlink configuration of at least one neighbouring cell.

15. A method according to claim 1, wherein the network comprises more nodes than there are communication devices served by the nodes.

16. An apparatus for a wireless device, the apparatus comprising at least one processor, and at least one memory including computer program code, wherein the at least one memory and the computer program code are configured, with the at least one processor, to
determine at the communication device at least one desired characteristic of a wireless service provided by at least one node of a network, and
trigger configuration of the wireless service by sending to the network a message containing information that is based on the at least one determined desired characteristic.

17. An apparatus for a node in a wireless network, the apparatus comprising at least one processor, and at least one memory including computer program code, wherein the at least one memory and the computer program code are configured, with the at least one processor, to
receive a message for triggering configuration of a wireless service, the message containing information that has been determined by a communication device based on at least one determined desired characteristic of the wireless service, and
in response thereto, cause configuration of the wireless service based on the received information.

18. An apparatus according to claim 17, configured to determine the capability of at least one serving node and/or at least one other node to provide the wireless service as indicated by the message, and to cause the configuration of the wireless service accordingly.

19. An apparatus according to claim 18, configured to send from the at least one serving node or a cluster head instructions to the at least one other node based on the determination.

20. An apparatus according to claim 17, configured to negotiate with the at least one other node regarding its capabilities to provide the wireless service and to cause handover of the communication device to the at least one other node.

21. An apparatus according to claim 17, configured to determine a serving pattern based on the information from the communication device and negotiations between nodes of the network, the serving pattern defining how the wireless service is provided for the communication device by a plurality of nodes.

22. An apparatus according to claim 17, wherein the message comprises information about uplink/downlink traffic ratio expected by the communication device and/or uplink/downlink configuration desired by the communication device and/or at least one candidate cell.

23. An apparatus according to claim 16, configured trigger a change in configuration of the wireless service in response to detection of an event indicative of a need for change in the configuration of the wireless service.

24. An apparatus according to claim 17, wherein the desired characteristic comprises at least one of expected uplink/downlink traffic ratio, preferred uplink/downlink configuration and uplink/downlink configuration of at least one neighbouring cell.

25. A computer program comprising code means adapted to perform the steps of claim 1 when the program is run on a processor.
